(19) United States
(12) Patent Application Publication
(10) Pub. No.: US 2006/0104629 A1
(43) Pub. Date: May 18, 2006

(54) Camera with image frame demarcation

(76) Inventors: James D. Boyd, Penfield, NY (US); Michael P. Cramer, Victor, NY (US); David J. Cornell, Scottsville, NY (US); David C. Smart, Fairport, NY (US); Joel S. Lawther, East Rochester, NY (US)

Correspondence Address: Mark G. Bocchetti;Patent Legal Staff, Eastman Kodak Company, 343 State Street, Rochester, NY, 14650-2201, US

(21) Appl. No.: 10/989,858

(22) Filed: Nov. 15, 2004

(51) Int. Cl. G03B 17/24

(52) U.S. Cl. 396/311

(57) ABSTRACT

A flash-capable photographic film camera is provided with an auxiliary light path to direct a portion of emitted flash light through an elongated secondary exposure window formed adjacent a side of the camera picture frame so as to expose an edge demarcation bar on the film in an interframe area between successive exposed picture frames. The secondary window preferably extends along substantially the full length of the picture frame side to produce a positive indication of an image frame edge for enhanced detection by conventional algorithm-based edge detectors irrespective of actual image frame density values.

### CROSS REFERENCE TO RELATED APPLICATIONS

Reference is made to commonly assigned, co-pending U.S. patent application Serial No. ______, [Attorney Docket No. 88958RLW], entitled: PHOTOGRAPHIC FILM NOTCHING SCANNER CORRECTION, filed Nov. 15, 2004, in the name(s) of David J. Cornell, Joel S. Lawther, David C. Smart.

### FIELD OF THE INVENTION

This invention is directed to the field of photographic film cameras and, in particular, such cameras having built-in flash units.

### BACKGROUND OF THE INVENTION

Photographic film developing processors typically employ film edge notching equipment to identify location of film frame on film. These notches are then used at the print apparatus to properly position image frame in the print frame for exposing the frame onto photographic paper. It is common practice, particularly in high speed photographic processing equipment, for the notching equipment to incorporate an algorithm-based optical scanner that detects the existence of a frame edge by detecting occurrence of a sharp change in density on the film. In normal situations, minimum film density corresponds to unexposed areas of the film, including the interframe regions between successive image frames and the detection of sharp increase in film density is interpreted as the beginning of an image frame. A notch is then punched into the longitudinal edge of the film in a fixed relationship to the detected frame edge.

Certain types of scenes captured onto the film by the camera result in hard to detect frame edges. Examples are flash exposures taken in dark ambient light conditions with scene objects located far beyond the effective range of the camera's flash capability, typically about fifteen feet from the camera. Pictures taken at a football game, or pictures of exploding fireworks are good examples of image frames that can result in undetectable differences between the minimum density values of the interframe area of the film and corresponding minimum density values of the attempted exposure areas within the image frame. Whenever frame edges are undetectable, notches are not created and no prints are made. It is not unusual for costumers to submit film rolls for processing in which all frames are these types of unsuccessfully exposed night time scenes. The result is that the processed roll is returned to the customer with the notation that the roll contained no image frames.

It is known in the photographic film camera art to provide auxiliary light paths for ambient light or diverted flash light in the camera to expose data, such as date or scene information, on the film within or adjacent the exposed image frame. These arrangements, however, are not concerned with providing an exposure on the film that is useful with algorithm-based edge detection scanners to indicate location of an image frame on the film.

U.S. Pat. No. 3,961,850 discloses an arrangement in a film camera that employs an auxiliary shuttered lens on the front of the camera to collect additional light during the picture taking process that is channeled to the film to expose a dot on the marginal edge of the film to provide what is described as an optical indexing or notching function. A scanner at the printer is used to detect the dot for positioning of the frame within the photographic printer frame. The described camera employs additional lens and shutter mechanisms that add to the bulk and the cost of the camera. Moreover, the dot is exposed along the marginal area of the film strip and would not be effective with existing edge detection algorithm-based scanners which are directed to detecting the interframe edges of the image frames. Additionally, the described arrangement relies on ambient scene light to achieve the dot exposure and would be ineffective in very low ambient light level picture-taking situations such as night time scenes.

There is therefore a need for a camera arrangement that would enable positive detection by algorithm-based interframe edge detectors of the existence and location of an exposed image frame on a film strip even when the exposed scene results in non-detectable or nearly non-detectable differences in film density between the exposed area of the image and the minimum density value of the interframe area of the film strip.

### SUMMARY OF THE INVENTION

In accordance with one aspect of the invention, therefore, there is provided a photographic film camera having a body, a taking lens, a shutter, a flash unit, a picture frame which defines an exposed image frame area on the film for capturing scenes on a film strip in successive image frame areas spaced apart by interframe regions extending transversely of the film strip, and an auxiliary light path within the camera body for directing a portion of light emitted by the flash unit toward the film strip. The camera is characterized by the provision in the auxiliary light path of an elongated exposure window that is positioned closely adjacent a side of the camera picture frame which defines one edge of the interframe region. The window extends substantially the full length of the picture frame side, such that flash emitted light exposes an elongated bar adjacent the exposed image frame so that, after development of the film, the exposed elongated bar has a uniform high density value that provides a positively detectable indication of existence of an image frame edge irrespective of actual density values of the image frame area.

In another aspect of the invention, there is provided a method of positively marking an edge of an image frame exposed on film in a camera of the type having a flash unit, in which the method comprises the steps of diverting through an auxiliary light path within the camera a portion of light emitted by the flash unit; and exposing the diverted light onto the film through an elongated exposure window positioned over an interframe region on the film closely adjacent the exposed image frame, thereby to provide, after film processing, an elongated high density value bar that provides a positively detectable indication of existence of and image frame edge irrespective of actual density values of the image frame area.

### BRIEF DESCRIPTION OF THE DRAWINGS

FIG. 1 is a front view of a photographic film camera with a built-in flash unit;

FIG. 2 is a sectional top view of the film camera of FIG. 1 illustrating a preferred embodiment of the invention;

FIG. 3 is a sectional rear view of the film camera of FIGS. 1 and 2;

FIG. 4 is an schematic illustration of a processed film strip showing frame edge demarcation created by the camera of FIGS. 1-3; and

FIG. 5 is a partial sectional view of a film camera according to an alternative embodiment of the invention.

### DETAILED DESCRIPTION OF THE INVENTION

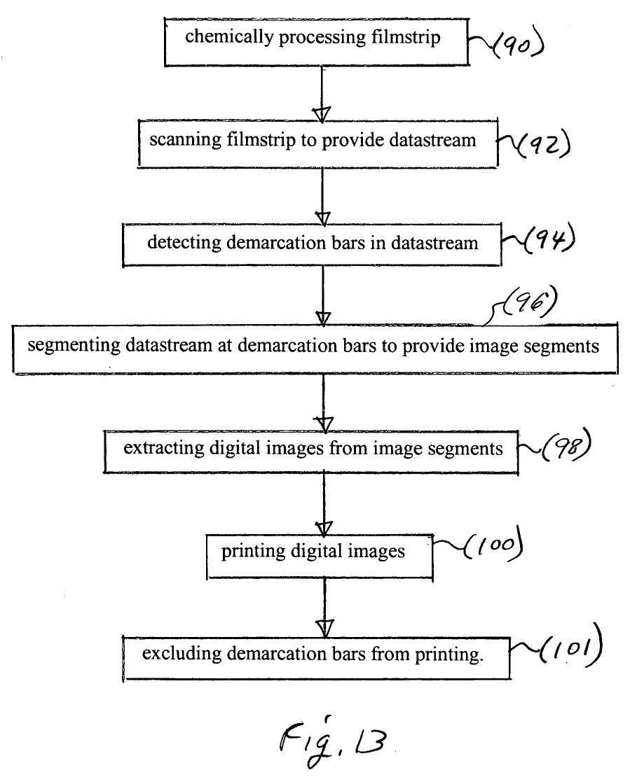

Referring jointly to FIGS. 1-3, there is shown a photographic film camera 10 having a body 12, taking lens 14, shutter 16, shutter release button 17, viewfinder 18 and flash unit 18. The camera also includes a supply chamber 20 for a conventional film cartridge 22 containing a film strip 24, a takeup chamber 26 for a takeup spool 28 for film strip 24. A film exposure chamber 30 is formed by partition walls 32a-32d the rearmost edges of which comprise a picture frame 34 which defines an exposed image frame area on the film strip. As shown in FIG. 5, a sequence of scenes captured by the camera are exposed onto the film strip in successive image frame areas 36 spaced apart by interframe regions 38 extending transversely of the film strip. Camera 10 further includes an auxiliary enclosed light path 40 defined by partition walls 26a, 32a, 42 and 44 within the camera body. An opening 46 in wall 44 adjacent flash unit 19 allows a portion of light emitted by the flash unit to enter path 40 and be directed toward the film strip 24.

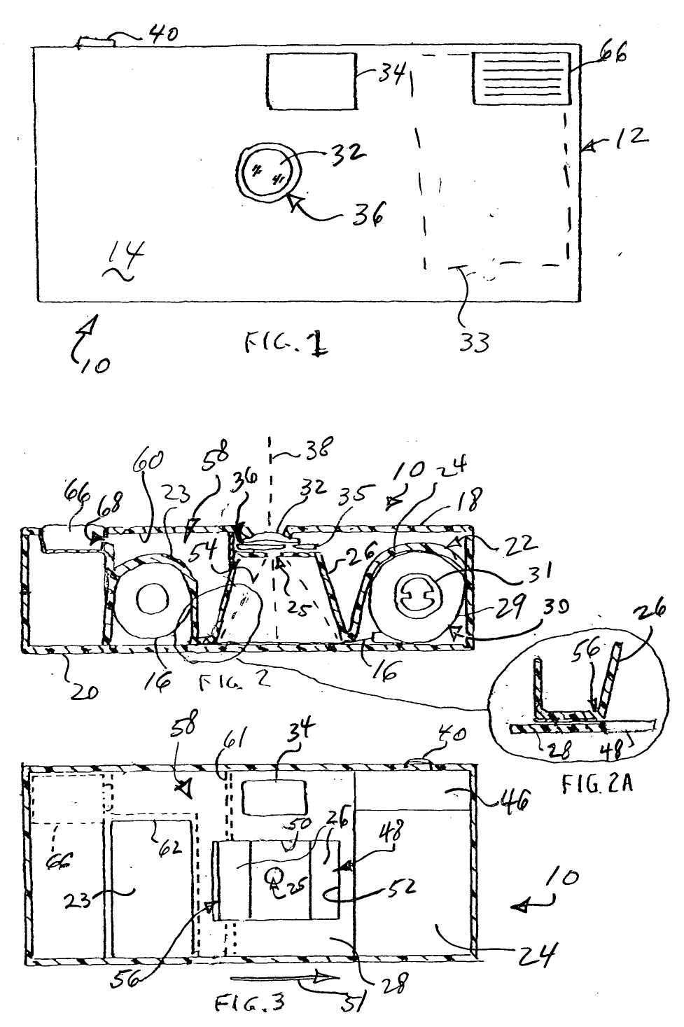

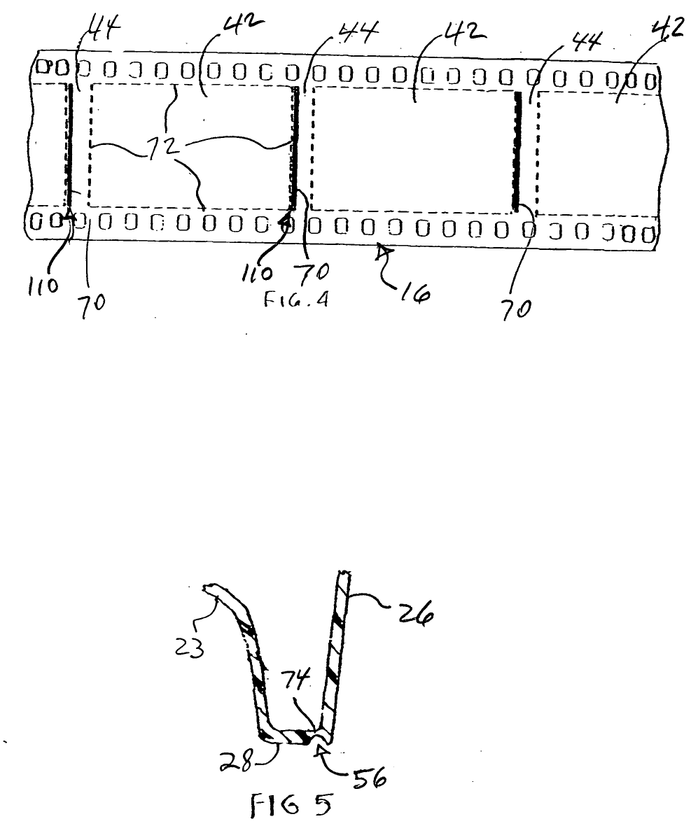

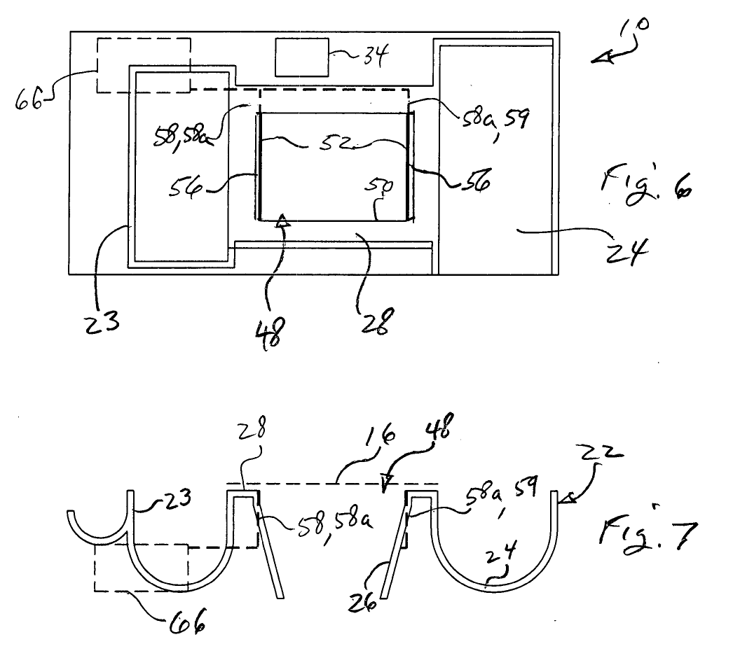

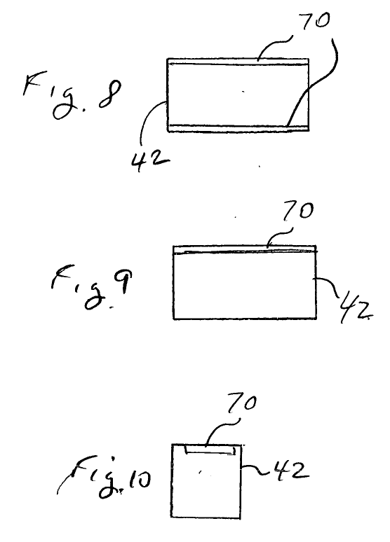

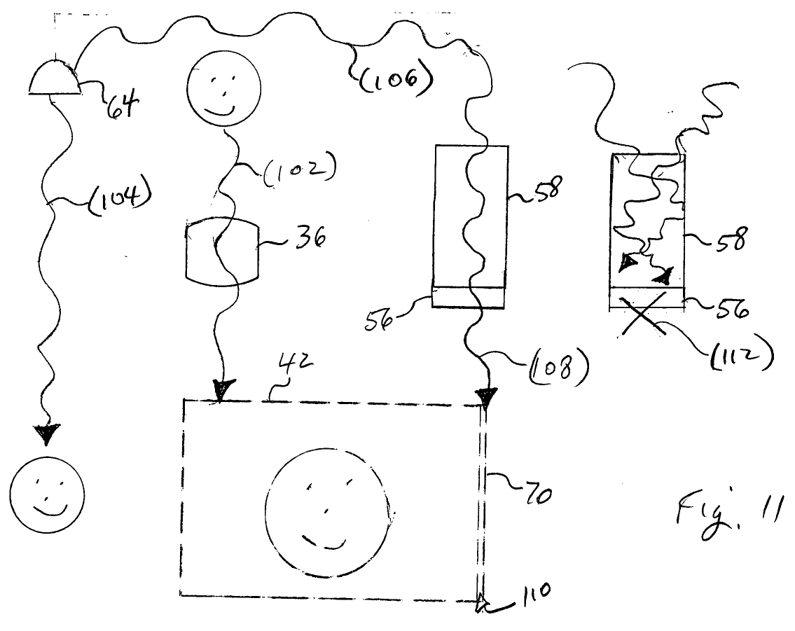

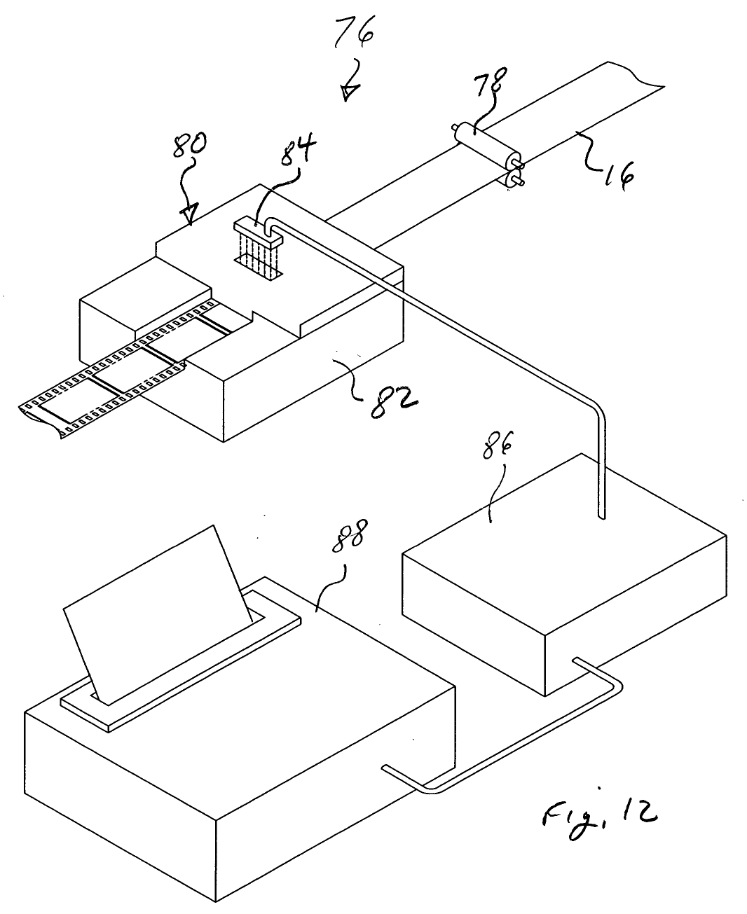

In accordance with a feature of the invention, the auxiliary light path 40 includes an elongated exposure window 50 which is positioned closely adjacent a side of the camera picture frame, wall 32a which defines a common edge on the film strip 24 between an image frame 36 and the adjacent interframe region 38. In the embodiment of FIGS. 2 and 3, window 50 consists of a through slot in the flange 52, preferably approximately ten-thousandths of an inch in width, between picture frame partition wall 32a and supply chamber wall 26a. Window 50 extends substantially the full length of the picture frame side, such that flash emitted light exposes an elongated frame edge demarcation bar 60 (FIG. 4) adjacent the exposed image frame so that, after development of the film, the exposed elongated bar has a uniform high density value that spans substantially all, and preferably all, of the side of the image frame to provide a positively detectable indication of the existence of an image frame edge irrespective of actual density values of the image frame area. Preferably, the slot of window 50 is slanted toward the picture frame area such the exposed demarcation line abuts the edge of the exposed image frame area thereby enhancing correct positioning of the image frame area in printing equipment.

Since frame edge detection algorithms employed in automated edge detection/notching equipment typically rely on sensing processed film density along a substantial, if not entire, lateral width of the image frame area of the film, extension of the exposed bar 60 along at least substantially all of the width of an exposed image area ensures proper edge detection by the algorithm-based edge detection equipment. Moreover, provision of the edge demarcation bar can act to markedly improve the efficiency of edge detection since the sharp increase in film density can speed up significantly the detection of an edge by making it unnecessary to perform extensive algorithm operations needed to ensure that small variations in density do or do not indicate the existence of an image frame such as would be the case when pictures are taken in low ambient light conditions.

Turning to FIG. 5, an alternate embodiment of the invention is shown in which a modified elongated exposure window 54 consists of a groove or partial slot approximately ten-thousandths of an inch in width on the film side of the window formed in the flange 52 adjacent the side wall 32a of the camera picture frame 34. This arrangement provides a thin wall portion 56 in the flange which serves to block any low light that might leak into the auxiliary path 40 while being sufficiently thin to permit the flash emitted light diverted into the path 40 to provide suitable exposure of the frame demarcation bar onto the film strip 24

The invention has been described in detail with particular reference to certain preferred embodiments thereof, but it will be understood that variations and modifications can be effected within the spirit and scope of the invention.

1. A photographic film camera having a body, a taking lens, a shutter, a flash unit, a picture frame which defines an exposed image frame area on the film for capturing scenes on a film strip in successive image frame areas spaced apart by interframe regions extending transversely of the film strip, and an auxiliary light path within the camera body for directing a portion of light emitted by the flash unit toward the film strip;
the camera characterized by:
the auxiliary light path including an elongated exposure window positioned closely adjacent a side of the camera picture frame which defines one edge of the interframe region, the window extending substantially the full length of said picture frame side, such that flash emitted light exposes an elongated bar adjacent the exposed image frame so that, after development of the film, the exposed elongated bar has a uniform high density value that provides a positively detectable indication of existence of an image frame edge irrespective of actual density values of the image frame area.

2. The camera of claim 1 wherein the picture frame includes a flange extending over the interframe region of the film strip and the exposure window comprises a slot in the flange that faces the film strip.

3. The camera of claim 2 wherein the slot is slanted toward the camera picture frame such the exposed elongated bar is positioned in abutting relation to the exposed image frame edge.

4. The camera of claim 1 wherein the picture frame includes a flange extending over the interframe region of the film strip and the exposure window comprises a groove formed partially through a face of the flange leaving a reduced thickness of the flange that effectively blocks passage of low light levels therethrough and serves to allow passage of the flash light therethrough.

5. The camera of claim 4 wherein a groove is formed in a face of the flange that faces the film strip.

6. The camera of claim 5 wherein the groove is formed immediately adjacent the picture frame area such that the exposed elongated bar is in abutting relation to the exposed image frame area.

7. The camera of claim 1 wherein the width of the elongated exposure window is approximately ten-thousandths of an inch.

8. The camera of claim 4 wherein the width of the elongated groove on the film facing side of the flange is approximately ten-thousandths of an inch.

9. A method in a photographic film camera having a flash unit of positively marking an edge of an image frame exposed on film in the camera, the method comprising:
diverting through an auxiliary light path within the camera a portion of light emitted by the flash unit; and
exposing said diverted light onto the film through an elongated exposure window positioned over an interframe region on the film closely adjacent the exposed image frame, so as to provide, after film processing, an elongated high density value bar that provides a positively detectable indication of existence and location of an image frame edge irrespective of actual density values of the image frame area.

10. The camera of claim 9 wherein the high density value bar is exposed in abutting relation to the image frame edge.
